(19) United States
(12) Patent Application Publication
(10) Pub. No.: US 2025/0198955 A1
(43) Pub. Date: Jun. 19, 2025

(54) ADJUSTING UNIT FOR AN X-RAY OPTICAL ELEMENT IN AN X-RAY FLUORESCENCE SYSTEM, AND X-RAY FLUORESCENCE SYSTEM

(71) Applicant: Helmut Fischer GmbH Institut fuer Elektronik und Messtechnik, Sindelfingen (DE)

(72) Inventor: Bruno Schroth, Boeblingen (DE)

(21) Appl. No.: 18/846,314

(22) PCT Filed: Jan. 19, 2023
(86) PCT No.: PCT/EP2023/051241

§ 371 Date: Sep. 12, 2024

(30) Foreign Application Priority Data
Mar. 14, 2022 (DE) 10 2022 105 838.7

(51) Int. Cl. G01N 23/223

(52) U.S. Cl. CPC G01N 23/223; G01N 2223/076; G01N 2223/1016

(57) ABSTRACT

Adjustment device for an X-ray optics in an X-ray fluorescence analyzer and X-ray fluorescence analyzer which comprises an X-ray source for generating an X-ray radiation which is focused with the X-ray optics onto a measurement object and with a detector by which an X-ray fluorescence radiation reflected by the measurement object can be detected, wherein a mounting frame is provided which accommodates a first frame which can be displaced in a first direction with respect to the mounting frame and with a second frame which is guided on the first frame so as to be displaceable in a second direction, wherein the first and second directions of the displacement movement of the frames differing from one another, in that a through opening is provided which extends through the mounting frame, the first frame and the second frame, and in that the X-ray optics can be arranged in the through opening.

The invention relates to an adjusting unit for an X-ray optics in an X-ray fluorescence analyzer and an X-ray fluorescence analyzer.

DE 10 2013 112 736 A1 discloses a method and a device for examining a sample with radiation emitted by an X-ray radiation source, which is guided via at least one beam-shaping unit to the sample carried by a sample holder, detected by a detector and evaluated in an evaluation unit. Before starting the examination of the sample, a radiation source and/or beam shape of the unit and/or sample holder and/or detector can be aligned or adjusted with respect to a predetermined fixed point and/or the beam path using a control unit via actuators.

DE 197 10 420 A1 discloses a method of a device for measuring the thickness of thin layers by means of X-ray fluorescence. This device for measuring layer thickness by means of X-ray fluorescence comprises an X-ray tube as well as a detector and an observation device with a focusing element, whereby the focusing element is mounted movably along its optical axis and is provided with a position measuring device. This avoids moving a table carrying the workpiece in such a way that the workpiece surface comes to rest at a predetermined measuring distance.

US 2015/0362639 A1 discloses an X-ray fluorescence analyzer with an X-ray tube, an X-ray detector and a camera for generating an optical image of the irradiated measuring point of a sample. An optical mirror is provided in the beam path, which has a window for the X-rays to pass through, which is covered with a film formed from a mirror layer.

An X-ray fluorescence analyzer is known from EP 1 100 092 B1, which comprises an X-ray source for generating X-rays. This X-ray radiation is focused onto a measurement object via X-ray optics. The secondary radiation emitted by the object to be measured is detected by a detector of the X-ray fluorescence analyzer and evaluated in a data processing device. It is also known to use two conically aligned reflective surfaces and a collimator at the exit end of the reflective surfaces to focus the X-rays onto a small focal spot or measuring point in order to irradiate the object to be measured with a high intensity.

The object of the invention is to propose an adjusting device for an X-ray optics in an X-ray fluorescence analyzer and an X-ray fluorescence analyzer in order to enable simple adjustment of an X-ray optics to an X-ray source.

This object is solved by an adjusting device for an X-ray optics in an X-ray fluorescence analyzer, which comprises a mounting frame which accommodates a first frame which is displaceable in a first direction relative to the mounting frame and comprises a second frame which is guided on the first frame so as to be displaceable in a second direction, wherein the first and second directions of the displacement movements of the frames are different from each other and that a through opening, in particular a central through opening, is provided which extends through the mounting frame, the first and second frame and in which the X-ray optics is arrangeable.

This adjustment device has the advantage that the X-ray optics for focusing the X-rays can be easily aligned and adjusted to the X-ray source. This allows an optical axis of the X-ray optics to be aligned with the X-rays emitted by the X-ray source. This adjustment is carried out in particular for commissioning the X-ray fluorescence analyzer. For example, due to heat development in the X-ray source during operation, the X-rays may drift relative to the beam axis of the X-ray optics. This adjustment device enables simple readjustment and exact alignment of the X-ray optics to the X-rays, for example during operation and/or after a predetermined operating time. The adjustment allows a high intensity of the X-ray radiation to be focused on a measuring point of the measuring surface, thereby enabling an increase in the counting rate of the X-ray fluorescence radiation for a detector of the X-ray fluorescence analyzer. The increased count rate can enable an improved evaluation of the emitted secondary radiation and thus of the measurement result. Thus, for example, a layer thickness measurement on the measurement object and/or a material analysis of a layer on the measurement object can be improved.

It is preferable that the X-ray optics arranged in the through opening can be displaced by the first and/or second frame in a plane perpendicular to the beam axis of the X-rays. This enables simple adjustment. Advantageously, an extension plane of the first and the second frame are aligned parallel to each other.

The X-ray optics, whose beam axis is preferably aligned with the Z axis, can be displaced in the X- and/or Y-direction by the first and/or second frame of the adjusting device. This allows a focal point of the X-ray optics to be easily aligned with the beam axis of the X-rays.

A first linear guide is provided between the mounting frame and the first frame and a second linear guide is provided between the first frame and the second frame, each of which can be adjusted using an actuator. This enables simple adjustment of the X-ray optics to the beam axis of the X-rays.

The first actuator for a displacement movement of the first frame to the mounting frame and the second actuator for a displacement movement of the first frame to the second frame are preferably aligned to a common operating side. As a result, accessibility to the adjusting device in the X-ray fluorescence analyzer from only one side is sufficient, in particular to adjust the displacement movements of the frames, which differ from each other by 90°.

Preferably, the first actuator comprises an adjusting screw, which is preloaded by a spring to the first frame on a flange which is fixed to the mounting frame. This makes it possible to eliminate any play or hysteresis of a threaded drive during a successive adjusting movement of the adjusting screw by turning it clockwise and counterclockwise, thus ensuring simple adjustment and increased precision.

Furthermore, a friction element is preferably provided between the adjusting screw of the first actuator and the flange. This makes it easy to prevent the adjusting screw from changing its set position independently.

The second actuator of the adjusting device preferably comprises an adjusting screw and an adjusting member, by means of which a 90° deflection of the adjusting movement of the adjusting screw for a displacement movement of the first frame to the second frame can be controlled. Advantageously, the actuator is preloaded by a spring relative to the first frame on a second flange, which is fixed to the second frame. The preloaded fixing of the actuator to the first frame can in turn create a backlash-free arrangement.

Furthermore, it is preferable that the second actuator has a clamping device for securing a set position of the adjusting screw. The set position of the adjusting screw can be secured after the first frame has been aligned with the second frame by slightly tensioning the clamping device with a clamping element. This can create friction between the adjusting screws and the second flange of the second adjusting screw.

It is advantageous that the linear guides of the adjusting device are designed as a ball guide. Such ball guides have the advantage that they can be controlled with a lower force when controlling a displacement movement. Alternatively, the linear guides can also be designed as a sliding guide or a combination of rolling and sliding guides.

The linear guide provided in the adjusting device preferably comprises two guide rods aligned in pairs and at a distance from each other, between which bearing rollers are arranged that are guided by a linear cage. The bearing rollers are preferably guided between the guide rods, which are aligned parallel to each other, and are displaceable along the guide rods.

The guide rods, which are arranged in pairs, are advantageously each inserted in a recess in the frame, with the recess having a width that is equal to or greater than the thickness of the two guide rods. A preloaded guide can be achieved by the bearing rollers and pressure pins arranged between the guide rods, which press on at least one side of a pair of the guide rods via a pressure element.

Preferably, the guide rods are secured in the recess by traverse pins that are aligned at right angles to the longitudinal axis of the guide rods. This makes it easy to fit and secure the guide rods.

Furthermore, to adjust the bearing play of the linear guides, it is advantageously provided that at least one pressure pin is aligned with the one recess of the respective frame. For example, the pressure pin can be aligned with an intermediate space between the guide rods arranged in pairs in the recess and engage at least partially in the intermediate space between the guide rods arranged in pairs in order to adjust the distance between the guide rods within the recess. Alternatively, it can be provided that a pressure element is assigned to a pair of the guide rods and the at least one pressure pin acts on the pressure element, which in turn acts on the guide rods assigned to each other in pairs. Both alternatives are used to adjust the bearing play of the linear guide.

For aligning and mounting the adjusting device in the X-ray fluorescence analyzer, the mounting flange preferably has a connection surface with at least one stop surface for aligning it. This enables simple positioning and mounting, in particular orthogonal alignment to the beam axis of the X-rays.

Furthermore, it is preferable for the X-ray optics to be detachably fastened in the through opening of the second frame using a holder or a mounting aid. The X-ray optics can be displaceable in the X- and/or Y-direction within the through opening of the first frame and the mounting frame.

According to a preferred further development of the adjusting device, it can be provided that a third frame is provided on the second frame, which is opposite the first frame and the X-ray optics can be arranged on the third frame, whereby a third actuator is provided between the second and third frame, by means of which a distance between the second and third frame can be adjusted. This means that the X-ray optics can also be adjusted along the beam axis of the X-rays, i.e. preferably along the Z-axis. This enables alignment to the anode, in particular to the point of origin of the X-ray beam at the anode.

The X-ray optics can be designed as a monocapillary or polycapillary, whereby in particular a polycapillary is provided in which the focal spot can have a diameter of between 30 μm and 600 μm or 10 μm and 100 μm or in particular less than 200 μm, such as 1 to 5 μm.

The object of the invention is further solved by an X-ray fluorescence analyzer in which an adjusting device according to one of the embodiments described above is provided, whereby the X-ray optics can be aligned with the X-ray source.

The invention and other advantageous embodiments and further embodiments thereof are described and explained in more detail below with reference to the examples shown in the drawings. The features to be taken from the description and the drawings can be used individually or in any combination in accordance with the invention. It shows:

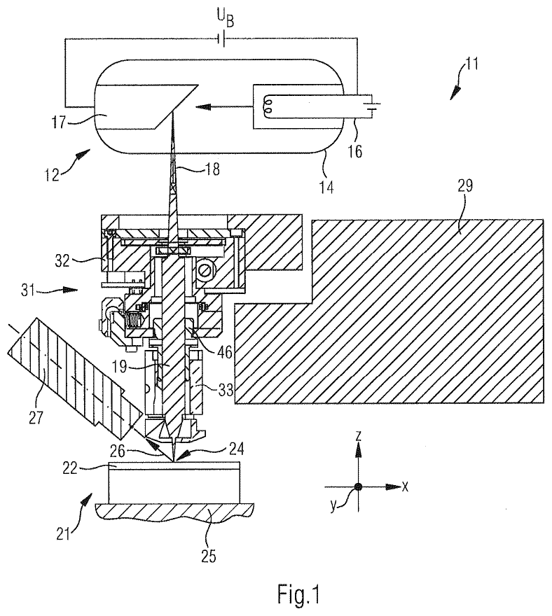

FIG. 1 a schematically simplified sectional view of an X-ray fluorescence analyzer,

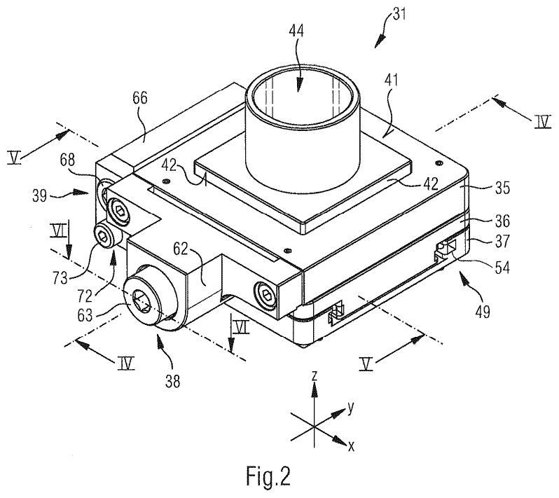

FIG. 2 a perspective view of an adjusting device,

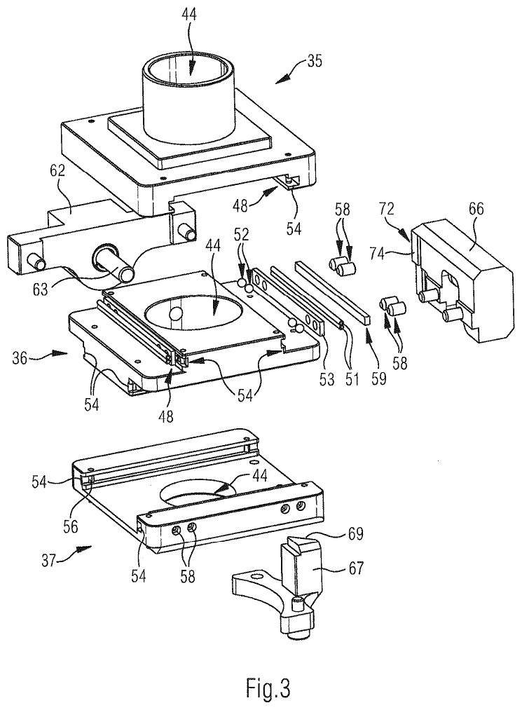

FIG. 3 an exploded perspective view of the components of the adjusting device shown in FIG. 2,

FIG. 4 a schematic sectional view along line IV-IV in FIG. 2,

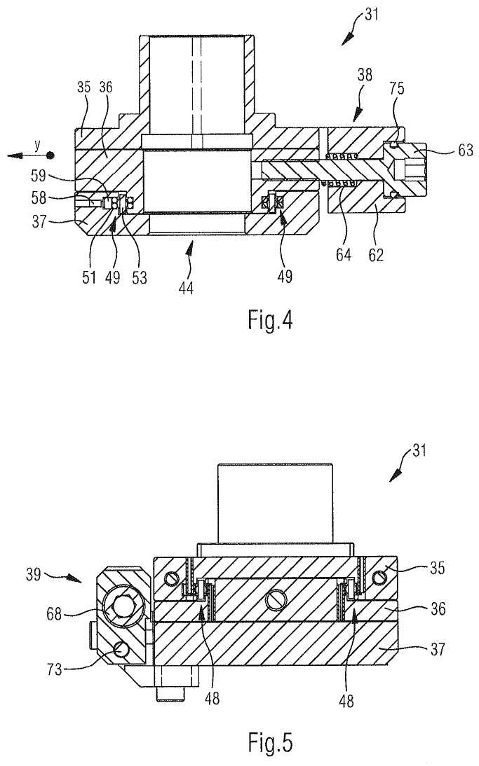

FIG. 5 a schematic sectional view along line V-V in FIG. 2, and

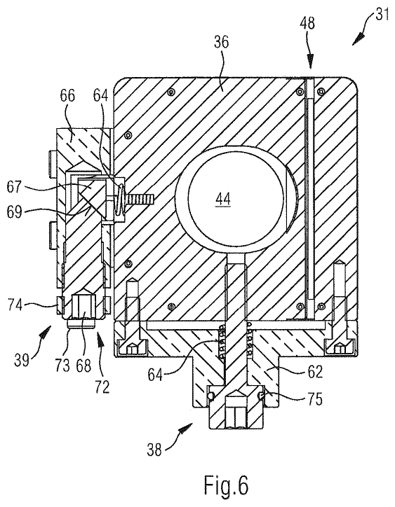

FIG. 6 a schematic sectional view along line VI-VI in FIG. 2.

FIG. 1 shows a simplified diagram of an X-ray fluorescence analyzer 11. This X-ray fluorescence analyzer 11 comprises an X-ray source 12, which is designed, for example, as an X-ray tube 14. This X-ray tube 14 comprises a glow cathode 16, from which electrons are emitted and accelerated towards an anode 17 by an applied acceleration voltage U_{B}. There, the electrodes are decelerated and X-rays 18 are generated. The wavelength range of the X-rays 18 depends on the acceleration voltage U_{B}, which can typically be in the range of 10 kV, in particular 50 kV, for example. The anode material can be tungsten or molybdenum, for example.

The X-rays 18 are focused by X-ray optics 19 and directed onto a measurement object 21. The measurement object 21 can, for example, have a coating 22 or a layer system. X-ray fluorescence radiation 26 is generated in a measurement spot 24 on or at the measurement object 21, in which the X-ray radiation 18 strikes the measurement object 21, and is detected by a detector 27, for example a semiconductor detector. By evaluating a detected energy spectrum, for example, a material composition of the coating 22 or of the measurement object 21 and/or the layer thickness of the at least one coating 22 can be determined.

In addition, the X-ray fluorescence analyzer 11 can comprise an optical device 29. This optical device 29 can be provided for monitoring and positioning the measurement object 21 in relation to the measurement position. This may also involve video observation. An adjusting device 31 is provided for arranging and holding the X-ray optics 19 in the X-ray fluorescence analyzer 11. This adjusting device 31 can be detachably attached to a further component 32 of the X-ray fluorescence analyzer 11. In the embodiment example, the component 32 can be a so-called shutter. A safety device 33 for the X-ray optics 19 is preferably provided below the adjusting device 31. In the embodiment example, the X-ray optics 19 is designed as a polycapillary. The X-ray optics 19 is aligned with the beam axis of the X-rays 18. Preferably, the beam axis of the X-rays 18 lies in a Z-axis. The adjusting device 31 allows the X-ray optics 19 to be moved in a plane perpendicular to the beam axis of the X-rays 18, i.e. the Z-axis. In particular, the adjusting device 31 enables adjustment in an X-Y plane, so that the beam axis of the X-ray optics 19 can be aligned with the beam axis of the X-rays 18, in particular so that they lie one inside the other.

FIG. 2 shows a perspective view of the adjusting device 31. The adjusting device 31 comprises a mounting frame 35. The adjusting device 31 can be attached to the other component 32 by means of this mounting frame 35. A first frame 36 is accommodated on the mounting frame 35 so as to be displaceable in one direction. A second frame 37 is provided on the first frame 36 and opposite the mounting frame 35, which is arranged on the first frame 36 so as to be displaceable in a different direction to the first frame 36.

A first actuator 38 is provided to control the displacement movement of the first frame 36 to the mounting frame 35. A second actuator 39 is provided for the displacement movement of the first frame 36 to the second frame 37. The first and second actuator 38, 39 are aligned to the same operating side, so that both actuators 38, 39 are easily accessible when the adjusting device 31 is installed.

A connection surface 41 is provided on the mounting frame 35 so that the adjusting device 31 is parallel to the alignment of a table axis of a schematically illustrated measuring table 25 on which the measurement object 21 can be positioned. This connection surface 41 has several stop surfaces 42, so that the adjusting device 31 can be rotated in 90° steps and the adjustment of the adjusting device 31 can be set from all sides.

The adjusting device 31 has a through opening 44. This is preferably provided centrally in the adjusting device 31. The through opening 44 extends through the mounting frame 35, the first frame 36 and the second frame 37. The X-ray optics 18 is detachably held on the second frame 37 by a mounting aid 46 (FIG. 1).

FIG. 3 shows a schematic exploded view of the components of the adjustment device 31 as shown in FIG. 2. The first frame 36 is guided to the mounting frame 35 by a linear guide 48. A second linear guide 49, which is offset by 90°, is provided between the first frame 36 and the second frame 37. These linear guides 48, 49 are preferably designed as ball guides.

The first and second linear guide 48, 49 are preferably of the same design. The linear guide 48, 49 comprises two pairs of opposing guide rods 51, between which bearing rollers 52 are positioned, which are guided by a linear cage 53. The first pair of guide rods 51 is provided, for example, in a recess 54 of the first frame 36. The second pair of guide rods 51 is provided in an opposite recess 54 on the mounting frame 35. For ease of manufacture, the recesses 54 extend completely along the entire length of the mounting frame 35 or first frame 36. To secure the guide rods 51 in the recesses 54, transverse pins 56 are provided, which are inserted into the recess 54 transversely to the longitudinal direction of the recess 54 and fix the guide rods therebetween.

Pressure pins 58 are provided for adjusting a bearing clearance of the linear guides 48, 49. These pressure pins 58 are inserted, for example, in the mounting frame 35 and can be operated from the outside, so that the distance between the guide rods 51 in the recess 54 of the mounting frame 35 and the guide rods 51 in the recess 54 in the first frame 36 can be adjusted. Furthermore, it may preferably be provided that a pressure element 59 or a pressure rod is provided in one of the two recesses 54 between the pressure pins 58 and the guide rods 51, which are aligned in pairs with respect to one another, in order to enable uniform pressure distribution and clearance adjustment.

This linear guide 48, 49 described above is provided in duplicate between the mounting frame 35 and the first frame 36 and advantageously between the first frame 36 and the second frame 37.

The first actuator 38 comprises a first flange 62, which is fixed to an end face of the mounting frame 35. The first flange 62 receives a set screw 63, which engages in a thread in the first frame 36. A compression spring 64 (FIG. 6) surrounding the adjusting screw 63 is provided between the first frame 36 and the first flange 62 in order to reduce or eliminate hysteresis when controlling the travel movement.

The second actuator 39 on the adjusting device 31 is offset by 90° to the first actuator 38. This second actuator 39 comprises a second flange 66, which is attached to the second frame 37. Furthermore, an adjusting member 67 is attached to the second frame 37, on which an adjusting screw 68 (FIG. 6) acts. The adjusting screw 68 has a conical tip which rests against and engages an inclined surface 69 of the adjusting member 67. The inclined surface 69 and the conical tip are aligned at an angle of 45° to the longitudinal axis of the adjusting screw 68 or to the direction of displacement of the first frame 36 relative to the second frame 37.

A clamping device 72 is provided on the second flange 66, which can be actuated by a clamping element 73, in particular a clamping screw. The adjusting screw 68 engages with a thread on a bendable clamping tab 74 arranged on the second flange 66 and on the second flange 66. By actuating the clamping element 73, a preload can be built up on the adjusting screw 68 via the bendable clamping tab 74. This results in increased friction between the adjusting screw 68 and the thread of the second flange 66. The second actuator 39 can be secured in the set position by friction.

FIG. 4 shows a schematic sectional view along line IV-IV in FIG. 2. It can be seen from this sectional view that a displacement movement of the first frame 36 in a Y-direction can be controlled by an adjusting movement of the adjusting screw 63 of the first actuator 38.

At the same time, the sectional view according to FIG. 4 shows the arrangement of the two linear guides 49 aligned parallel to one another for a displaceable mounting of the first frame 36 on the second frame 37.

FIG. 5 shows a schematic sectional view along line V-V in FIG. 2. It can be seen from this sectional view that the first frame 36 is slidably received by two parallel linear guides 48 to the mounting frame 35.

FIG. 6 shows a schematic sectional view along line VI-VI as shown in FIG. 2. The adjusting screw 63 of the first actuator 38 can preferably be designed with a friction element 75. As a result, an adjustment position of the adjusting screw 63 can be secured, in particular by the interaction with the compression spring 64. The friction element 75 can be an O-ring.

The sectional view of the second actuator 39 shows a 90° deflection of an infeed movement of the adjusting screw 68 onto the actuator 67. Preferably, the second frame 37 and the actuator 67 are arranged relative to each other under pretension by a compression spring 64.

During operation of the X-ray source 12, the heating of the X-ray source 12 can lead to inaccuracies due to thermal expansion of components of the X-ray fluorescence analyzer 11. The adjusting device 31 can be used to move the X-ray optics 19 positioned in the through opening 44 perpendicular to the beam axis of the X-rays 18 in an X/Y direction. This allows the beam axis of the X-ray optics 19 to be adjusted to the beam axis of the X-ray source 12. This leads to an increased intensity of the X-rays 18 in the measuring spot 24 and to an improved evaluation of the measured values.

1. Adjusting device for an X-ray optics in an X-ray fluorescence analyzer, which comprises an X-ray source for generating X-ray radiation which is focused with the X-ray optics onto a measurement object and with a detector, by means of which X-ray fluorescence radiation reflected by the measurement object is detectable,
wherein
a mounting frame is provided which accommodates a first frame which is displaceable in a first direction relative to the mounting frame and with a second frame which is guided on the first frame so as to be displaceable in a second direction, the first and second directions of the displacement movement of the frames differing from one another,
a through opening is provided, which extends through the mounting frame, the first frame and the second frame, and
the X-ray optics is arrangeable in the through opening.

2. Adjusting device according to claim 1, wherein the X-ray optics arranged in the through-opening is displaceable by the frames in a plane perpendicular to a beam axis of the X-ray optics arranged in the through-opening.

3. Adjusting device according to claim 2, wherein the X-ray optics is displaceable in the X- and/or Y-direction by the first and/or second frame and the beam axis of the X-ray optics preferably lies in a Z-axis.

4. Adjusting device according to claim 1, wherein a first linear guide is provided between the mounting frame and the first frame and a second linear guide is provided between the first frame and the second frame, which are each adjustable by an actuator.

5. Adjusting device according to claim 4, wherein the first actuator for controlling a displacement movement of the first frame to the mounting frame and the second actuator for controlling a displacement movement of the first frame to the second frame are aligned to a common operating side.

6. Adjusting device according to claim 4, wherein the first actuator comprises an adjusting screw which is provided preloaded by a compression spring between the first frame and a first flange which is fixed to the mounting frame.

7. Adjusting device according to claim 6, wherein a friction element is provided between the adjusting screw and the flange.

8. Adjusting device according to claim 4, wherein the second actuator comprises an adjusting screw and an adjusting member, by means of which a 90° deflection of an adjusting movement of the adjusting screw is controllable and the adjusting member is arranged preloaded relative to the first frame by a compression spring and is fastenable to the second frame.

9. Adjusting device according to claim 8, wherein the second flange, which is fastened to the second frame, has a clamping device for securing the position of the adjusting screw of the second actuator, in particular by friction.

10. Adjusting device according to claim 4, wherein the linear guide is designed as a ball guide or sliding guide.

11. Adjusting device according to claim 4, wherein the linear guide comprises two guide rods which are aligned in pairs and at a distance from one another and between which bearing rollers are provided which are guided by a cage of linear design.

12. Adjusting device according to claim 11, wherein the guide rods arranged in pairs are provided in a recess on the mounting frame and/or first frame and/or second frame and the height of the recess is equal to or greater than the thickness of the two guide rods lying one above the other.

13. Adjusting device according to claim 11, wherein the guide rods are secured in the recess by transverse pins which are aligned at right angles to the longitudinal axis of the guide rods.

14. Adjusting device according to claim 11, wherein at least one pressure pin engages in the recess, which is aligned with an intermediate space between the guide rods assigned to one another in pairs, or in that the at least one pressure pin engages on a pressure element, which bears against the guide rods aligned in pairs, and a bearing play of the linear guide is adjustable by the at least one pressure pin.

15. Adjusting device according to claim 1, wherein a connection surface with at least one stop surface for aligning an operating side in the X-ray fluorescence analysis device is provided on the mounting frame.

16. Adjusting device according to claim 1, wherein the X-ray optics is detachably fastened in the through-opening of the second frame by means of a mounting aid and is displaceable in the X and/or Y direction within the through-opening of the first frame and the mounting frame.

17. Adjusting device according to claim 1, wherein a third frame is provided on the second frame, which is opposite the first frame, and a third actuator is provided for actuating the third frame, by means of which a distance between the second frame and the third frame is adjustable to the X-ray source along a beam axis of the X-rays.

18. Adjusting device according to claim 1, wherein the X-ray optics is designed as a monocapillary or polycapillary.

19. X-ray fluorescence analyzer with an X-ray source for generating X-ray radiation and with X-ray optics for focusing the X-ray radiation onto a measurement object, having a detector for detecting an X-ray fluorescence radiation reflected by the measurement object and having a data processing device for detecting and evaluating the X-ray fluorescence radiation, wherein the X-ray optics is alignable with respect to the X-ray source by means of an adjusting device according to claim 1.
